(19) United States
(12) Patent Application Publication
(10) Pub. No.: US 2008/0220739 A1
(43) Pub. Date: Sep. 11, 2008

(54) BILLING A COLLECT CALL TO A CELLULAR TELEPHONE

(75) Inventors: Stephen A. Muoio, Cross River, NY (US); Joseph Guariglia, Peekskill, NY (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Touchtone Technologies, Inc., Bedford Hills, NY (US)

(21) Appl. No.: 11/972,492

(22) Filed: Jan. 10, 2008

Related U.S. Application Data
(60) Provisional application No. 60/879,617, filed on Jan. 10, 2007.

(51) Int. Cl. H04M 11/00

(52) U.S. Cl. 455/406

(57) ABSTRACT

There is provided a method for billing a collect call to a cellular telephone. The method includes (a) obtaining, from a party at a cellular telephone, consent to pay for a call, and (b) sending to the cellular telephone, a text message that contains an invoice for the call.

### BACKGROUND OF THE INVENTION

1. Field of the Invention

The present disclosure relates to collect calls or operator-assisted calls, billed to cellular phones. Called parties are given an option to accept phone calls by giving permission to bill that call to the cellular phone used to accept that call. Advertising, surveys and sweepstakes options are also offered via telecommunications, an interactive voice response (IVR) or voice portal system, as a means of payment in addition to short message service (SMS) text billing. This platform can also be used to host a variety of billing options for products and services other than phone calls.

2. Description of the Related Art

Telecommunications providers typically do not have the ability to bill calls to cell phones and as a result they block or drop these call types. Techniques for billing calls to cell phones do not presently exist, and so service providers try to persuade the calling party to pay for the call with a credit card.

Accordingly, a need exists for an effective way to process and bill a collect call to a cellular telephone.

### SUMMARY OF THE INVENTION

There is provided a method for billing a collect call to a cellular telephone. The method includes (a) obtaining, from a party at a cellular telephone, consent to pay for a call, and (b) sending to the cellular telephone, a text message that contains an invoice for the call.

### BRIEF DESCRIPTION OF THE DRAWINGS

FIG. 1A is a flowchart of a method for billing a collect call to a cellular telephone, showing the steps of the method as it relates to a calling party.

FIG. 1B is a flowchart of a method for billing a collect call to a cellular telephone, showing the steps of the method as it relates to a called party.

FIG. 2 is a flowchart of a method for billing a collect call to a cellular telephone, showing the steps of the method as it relates to a called party who desires to learn about alternative payment options.

FIGS. 3 and 4 are a flowchart of a method in which a party who has previously agreed to pay for a call can either make the payment, or in the alternative, pay for the call by participating in a marketing program.

FIG. 5 is a block diagram of a system for performing the methods described herein.

### DESCRIPTION OF THE INVENTION

There is provided a system, referred to herein as a bill-to-cell-direct (BTCD) platform, for billing a collect call to a cellular telephone. A calling party or a person being called accesses the BTCD platform by one of (a) calling a toll free number, (b) logging on to a web site, or (c) via a transfer from their telephone service provider. The BTCD platform benefits the telephone service provider by increasing their call volume, adding additional value to their customers, enhancing their platform, and providing calling parties with multiple billing options. The options include paying for the call directly, by receiving an SMS invoice by way of email to the cell phone, or by listening to an advertisement or participating in a survey or sweepstake program in exchange for payment. Additionally, if the calling party is willing to participate, general data can be gathered and used for future marketing efforts. Such data includes cell phone number, mailing address, geographic information about the calling party and called party, and domestic and international calling patterns.

The BTCD platform provides an effective way to bill collect calls, also known as reversing the charges or a billed to called party call, as well as other non-telecom services, to cellular phones, processed by an automated operator, e.g., IVR, or a live operator. Invoicing of these calls is done through an automated process that sends an SMS text messages to the called party's cellular phone. This SMS text message serves as an invoice for charges for making this call and reversing the charges, i.e., billing collect. Additionally, if the called party does not remit payment within a designated time period, a reminder message is sent both in the form of an SMS text message and a voice message, both containing billing payment information.

Through a series of automated prompts, the calling party inputs the number to be called, and records his or her name. The BTCD platform will then initiate another call to the called party, who will record their acceptance of this call, and give authorization for an invoice to be received on that cell phone, or agree to listen to a short advertisement in lieu of payment. Once an invoice is sent to the cell phone using SMS technology, the receiving party will have the option to call a customer center, send a check, or pay by credit card. An account number will be generated consisting of the called party's cell phone number. If the party who authorized the call disputes the call or the charges, they have an option to listen to their recorded acceptance of the call. Another payment option is for potential consumers to participate in selected programs, such as surveys, sweepstakes, lotteries, or advertising and promotional programs. In an exemplary embodiment, system access is provided to the consumer via a telephone and a prompt is provided to allow the consumer to indicate if he or she is willing to participate in the provided program. If the consumer indicates he or she would like to participate, then a pre-determined program is provided. Upon completion, the consumer is awarded a reward for such participation, which can be used to pay for the call or an outstanding cell phone bill. The calling party can also transfer off of the BTCD platform and be connected directly to an advertiser fulfillment center.

Preferably, a consumer initiates the process by placing a phone call. The call may be placed or routed via one of several calling systems and various communications service providers, such as an operator service provider, a competitive local exchange carrier (CLEC), a pre-paid calling card provider, a cellular or pager service provider, a pay-phone provider, or other provider of communication services. Via the communications service provider, the call is forwarded to the BTCD platform. The consumer is offered a menu of options that will allow him or her to listen to a program in exchange for a reward. Examples of the content of the program are an advertisement of a product, a promotional message, an interactive survey, informational messages, or a collection of demographic data. Any number of various message contents could be employed as the program, and can be modified each time a call comes in from the same phone number. In an exemplary embodiment, a message is provided that asks the consumer if they are interested in hearing an advertisement in exchange for receiving a reward. The consumer responds via keypad entry or voice command to accept or reject the offer to listen to the advertisement and receive a reward.

The reward offered to the consumer could be one of a number of possible reward options. For example, the consumer could be offered a reduced rate or free call on the call that he or she is about to place or has accepted payment for. Alternatively, additional calling minutes could be applied to future calls as a reward. Other types of reward offers could include a discount on a particular advertised product or a credit towards a point system reward product offered by a particular retailer (e.g., Pepsi® points), or other rewards programs offered by the product manufacturers or retailers.

If the consumer has been elected not to pursue any billing options, the call will not be processed or the option of allowing the calling party to listen to an advertisement will be given and an instantaneous adjustment to the charges or a credit allowing the calling party to proceed with their call.

Additional embodiments of the BTCD platform include systems that offer both audio and visual content. For example, in addition to audio content that may include the recorded name of the calling party, the recorded acceptance of the call is also available by calling to the call center or logging onto a website. Advertising messages, interactive surveys, promotional alerts, etc. and may be offered by recordings, by live operators, or through the website, that allow for visual content such as text messages, pictures, movies, etc. to be received. Using these capabilities, visual content can be included in the program provided to the consumer, e.g., an advertisement can be played on the display in addition to or instead of an audio advertisement.

Additionally, many cellular devices have the ability to provide Internet access. An embodiment of the present disclosure includes directing the consumer to a web site, which can be the advertiser's website or a site provided by the system provider. The inclusion of a website in the system also allows for access at a later time by the consumer. For example, the consumer may later decide to purchase the product, and can do so by accessing the website, or alternatively the website provides an outlet for consumers to check awards balances.

The BTCD platform 1) helps the telecommunications carrier process more calls, 2) provides enhanced services and additional billing options to the carrier's customers, 3) enhances the carrier's revenues by processing theses calls and possibly sharing in the adverting dollars, 4) helps the advertiser to identify its target customer after a consumer opts for the advertiser's ad or promotion, 5) helps advertisers to acquire business from target customers that will come to them to redeem points they've earned, 6) helps advertisers adapt their key messages to the culture of each customer-type, 7) allows advertisers to change ads in real-time, and 8) allows consumers to interact with the advertiser by selecting “push-button” options available during and/or after the audio ad, for example: “Please, press “2” to connect with the advertiser”.

The system described herein creates a “win-win” (win) scenario for telecoms, advertisers and customers by (1) helping telecommunication carriers obtain higher efficiencies, identify areas of growth and develop expansion strategies leading to additional streams of revenue, in order to overcome the hurtle of further commoditization and growing competition from newly reformed telecom conglomerates; (2) lowering telephone rates for the telephone-addicts and/or increasing talk-time for the money; and (3) developing a new, innovative and efficient medium for all types of advertisers.

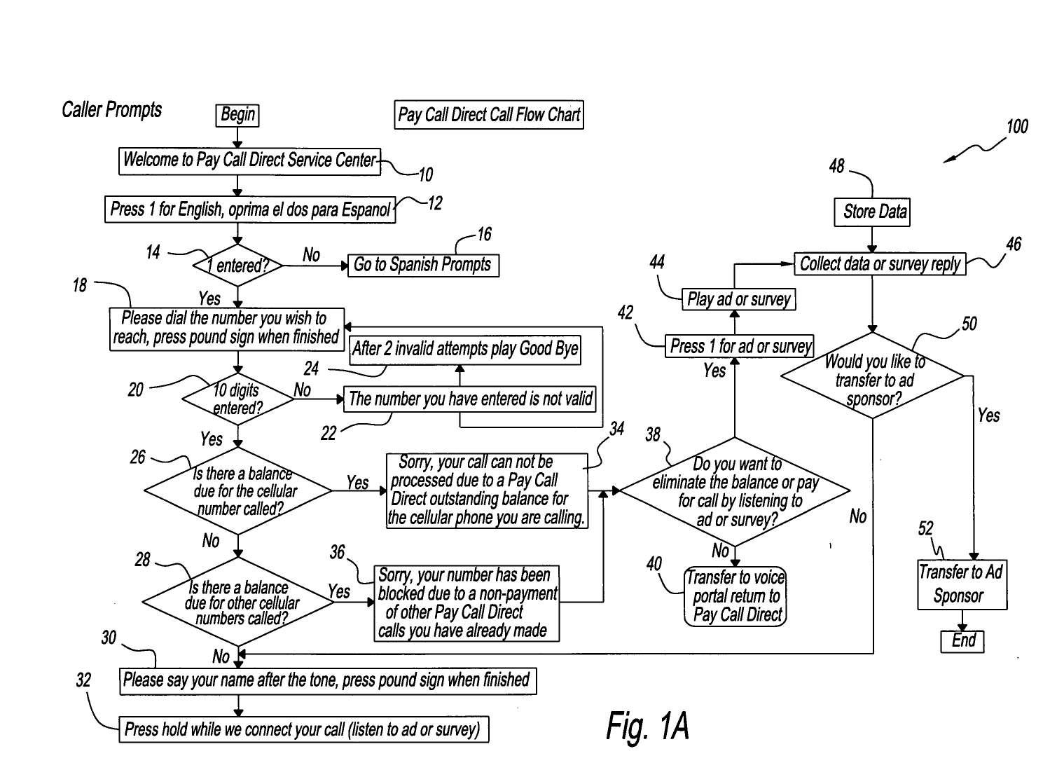

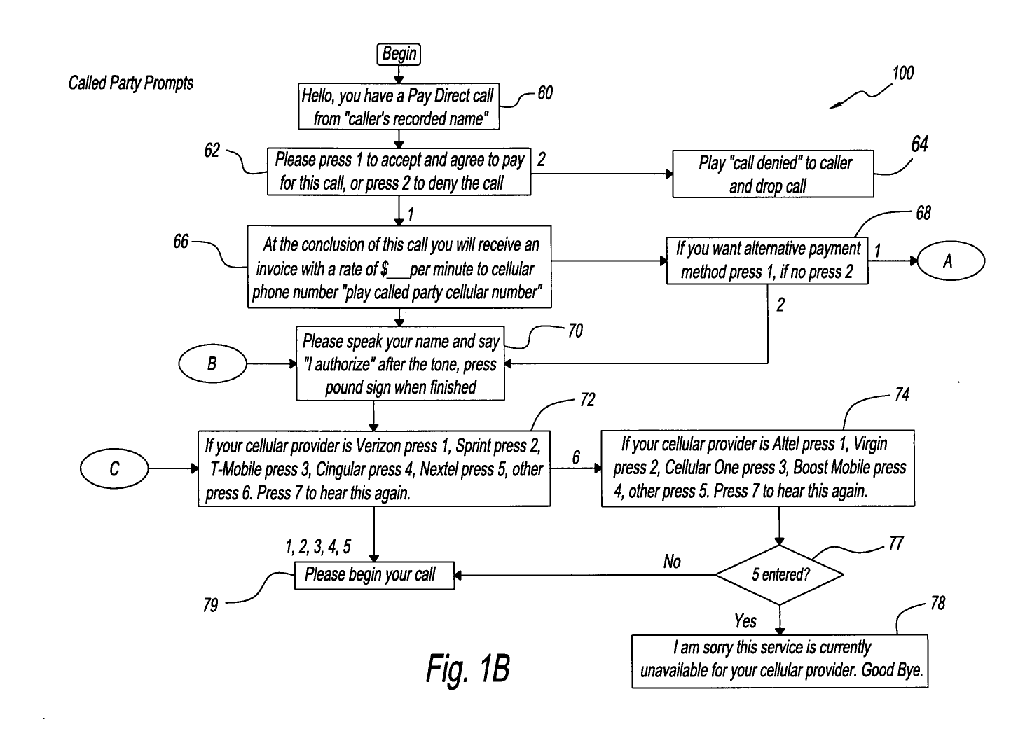

FIGS. 1A and 1B are a flowchart of a method 100 for billing a collect call to a cellular telephone. FIG. 1A shows the steps of method 100 as it relates to a calling party, and FIG. 1B shows the steps of method 100 as it relates to a called party. In method 100, the calling party wishes to make a collect call to the called party. Method 100 is performed by a BTCD platform, on behalf of a service provider referred to herein as Pay Call Direct.

FIG. 1A, as mentioned above, shows the steps of method 100 as it relates to the calling party.

In step 10, the BTCD platform prompts the calling party with “welcome to the Pay Call Direct service center”. Method 100 then progresses to step 12.

In step 12, the BTCD platform prompts the calling party with “press 1 for English, or press 2 for Spanish”. Other languages can also be offered. Method 100 then progresses to step 14.

In step 14, the BTCD platform considers the calling party's input from step 12. If the calling party pressed 2, then method 100 advances to step 16. If the calling party pressed 1, then method 100 advances to step 18.

In step 16, the BTCD platform directs the calling party to Spanish language prompts.

In step 18, the BTCD platform directs the calling party to English language prompts and asks for the calling party to dial the number he or she wishes to reach, and press pound sign when finished. Method 100 then progresses to step 20.

In step 20, the BTCD platform determines whether the calling party has entered a minimum of 10 digits. If the number of digits entered is not correct, then method 100 advances to step 22. If the number of digits is correct, then method 100 advances to step 26.

In step 22, the BTCD platform plays a message such as “The number you have entered is not valid”, and then method 100 branches back to step 18. After two invalid attempts to enter the 10-digit number, method 100 branches to step 24.

In step 24, the BTCD platform plays a message “good bye”, and drops the call.

In step 26, the BTCD platform checks to determine if there is a balance due for the cellular number called. If no balance is due, then method 100 advances to step 28. If a balance is due, then method 100 branches to step 34.

In step 28, the BTCD platform determines if there is a balance due for other cellular numbers called. If no balance is due, then method 100 advances to step 30. If a balance is due, then method 100 branches to step 36.

In step 30, the BTCD platform prompts the calling party to (i) say his or her name after the tone, and (ii) press the pound sign when finished. Method 100 then progresses to step 32.

In step 32, the BTCD platform issues a message that states, “Please hold while we connect your call”. While the calling party is on hold, an advertisement, survey or message will be played.

In step 34, the BTCD platform issues a message that states, “Sorry, your call can not be processed due to a Pay Call Direct outstanding balance for the cellular phone you are calling”. Method 100 then progresses to step 38.

In step 36, the BTCD platform issues a message that states, “Sorry, your number has been blocked due to non-payment of other Pay Call Direct calls you have already made”. Method 100 then progresses to step 38.

In step 38, rather than simply hanging up on the calling party or seeking a credit card payment, the BTCD platform inquiries as to whether the calling party would like to eliminate the balance, or avoid the cost of the call, by listening to a sponsored ad, participating in a survey or sweepstakes, etc. If the calling party indicates “no”, then method 100 advances to step 40. If the calling party indicates “yes”, then method 100 advances to step 42.

In step 40, the calling party is transferred to a voice portal and returned to Pay Call Direct when done.

In step 42, the BTCD platform requests that the calling party “Press 1 for ad, survey or sweepstakes”. Method 100 then proceeds to step 44.

In step 44, the BTCD platform plays the ad, survey or sweepstakes. Method 100 then proceeds to step 46.

In step 46, the BTCD platform collects data, e.g., the calling party's responses, based on the calling party's interaction with the material presented in step 44. The BTCD platform stores the data to a storage device 48, and then method 100 progresses to step 50.

In step 50, the BTCD platform prompts the calling party to determine if the calling party would like to be transferred directly to the ad sponsor. If the calling party indicates “no”, then method 100 branches to step 30. If the calling party indicates “yes”, then method 100 advances to step 52.

In step 52, the BTCD platform sends the calling party to the ad sponsor.

FIG. 1B, as mentioned above, shows the steps of method 100 as it relates to the called party.

In step 60, the BTCD platform calls the called party and states, “Hello, you have a Pay Call Direct call from (calling party's recorded name)”. Method 100 then progresses to step 62.

In step 62, the BTCD platform prompts the called party to, “Please press 1 to accept and agree to pay for this call, or press 2 to deny the call”. If the called party presses “1”, then method 100 progresses to step 66. If the called party presses “2”, then method 100 progresses to step 64.

In step 64, the call is denied to the calling party, and the call is dropped.

In step 66, the BTCD platform plays a message that states, “At the conclusion of this call you will receive an invoice for a rate of (provide rate) per minute to cell phone number (play the called party's cell phone number)”. Method 100 then progresses to step 68.

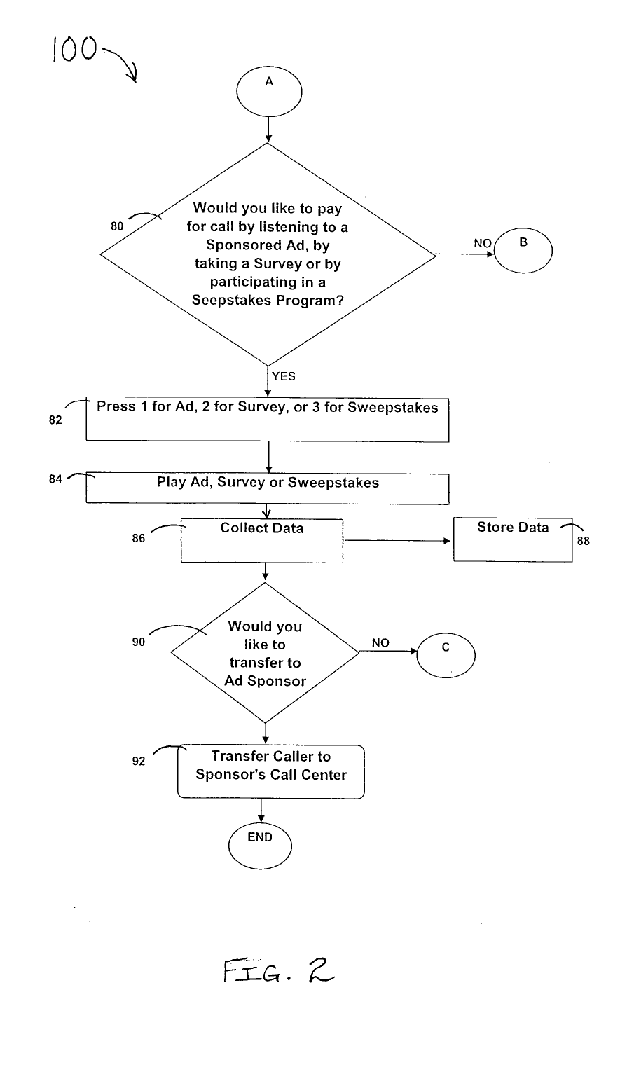

In step 68, the BTCD platform inquiries as to whether the called party wishes to explore alternative payment options (by pressing “1”) or not (by pressing “2”). If the called party presses “1”, thus indicating a wish to explore alternative payment options, then method 100 branches to step 80 (see FIG. 2). If the called party presses “2”, thus indicating that the called party does not wish to explore alternative payment options, then method 100 progresses to step 70.

In step 70, the BTCD platform plays a message that states, “Please speak your name and say “I authorize” at the tone, and press pound sign when finished”. Method 100 then progresses to step 72.

In step 72, the BTCD platform attempts to determine the cellular service provider that the called party utilizes. This is because, in steps below, the BTCD platform may send an email to the called party's cellular telephone, and the email address is often derived from a domain name associated with the service provider, e.g., verizon.com. Accordingly, in step 72, the BTCD platform inquiries as to which cellular service provider the called party utilizes, e.g., “If your cellular provider is Verizon press 1, Sprint 2, T-Mobile 3, Cingular 4, Nextel 5, other 6, or press 7 to hear this list again”. If “1, 2, 3, 4, or 5” is selected, then method 100 advances to step 79. If “6” is selected, then method 100 advances to step 74.

In step 74, the BTCD platform further prompts the called party, “If your cellular provider is Alltel press 1, Virgin Atlantic 2, Cellular One press 3, Boost 4, or other 5”. From step 74, method 100 advances to step 77.

In step 77, the BTCD platform considers the response of the called party from step 74. If the called party selected 5, then method 100 advances to step 78, otherwise, method 100 advances to step 79.

In step 78, the BTCD platform drops the call. This is because the called party has not identified a service provider, and therefore, the BTCD platform cannot readily derive the email address associated with the called party's cellular telephone. However, as an alternative to dropping the call, the BTCD platform may generate a plurality of possible email addresses by associating the called party's cellular telephone number with domain names of which the BTCD platform is aware, and sending the email to each of the generated email addresses. Accordingly, if the BTCD platform does not drop the call, then method 100 will progress from step 78 to step 79.

In step 79, the BTCD platform connects the calling party to the called party, and prompts the called party to “Please begin your call”. The BTCD platform stores entered data from the calling party so if repeat calls are made, the data is auto populated. After the call is completed, the BTCD platform sends a text message, via email, to the called party's cellular telephone, where the text message contains an invoice for the call. The email address of the cellular telephone can be derived from the called party's telephone number, and the name of the called party's service provider, e.g., “2125551212@Verizon.com”.

Briefly, in summary, in accordance with method 100, the BTCD platform (a) in step 62, obtains from the called party, at a cellular telephone of the called party, the called party's consent to pay for the call, and (b) in step 79, provides a connection for the call from the calling party to the called party, and sends to the cellular telephone, a text message that contains an invoice for the call.

FIG. 2 is a flowchart of method 100 as it relates to a called party who desires to learn about alternative payment options.

In step 80, the BTCD platform inquires as to whether the called party would like to pay for the call by listening to a sponsored ad, participating in a survey or participating in a sweepstakes program. If “no”, then method 100 branches to step 70 (FIG. 1B). If “yes”, then method 100 advances to step 82.

In step 82, the BTCD platform invites the called party to press 1 to listen to a sponsored advertisement or promotion, press 2 to participate in a survey, press 3 to participate in a sweepstake, etc. Method 100 then progresses to step 84.

In step 84, the BTCD platform presents material to the called party, in accordance with the selection that the called party made in step 82. From step 84, method 100 advances to step 86.

In step 86, the BTCD platform collects data, e.g., the called party's responses, based on the called party's interaction with the material presented in step 84. The BTCD platform stores the data to a storage device 88, and then method 100 progresses to step 90.

In step 90, the BTCD platform asks whether the called party is interested in being transferred directly to an ad sponsor. If “yes”, then method 100 advances to step 92. If “no”, then method 100 branches to step 72 (FIG. 1B).

In step 92, the called party is transferred to the ad sponsor, and the call is ended.

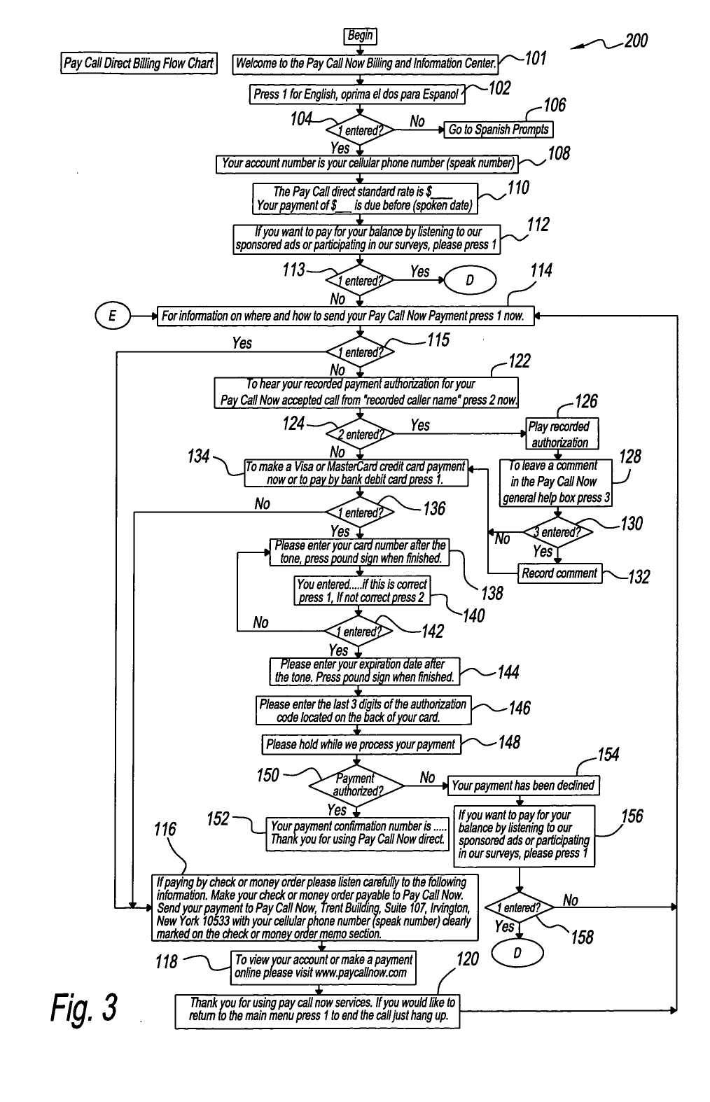

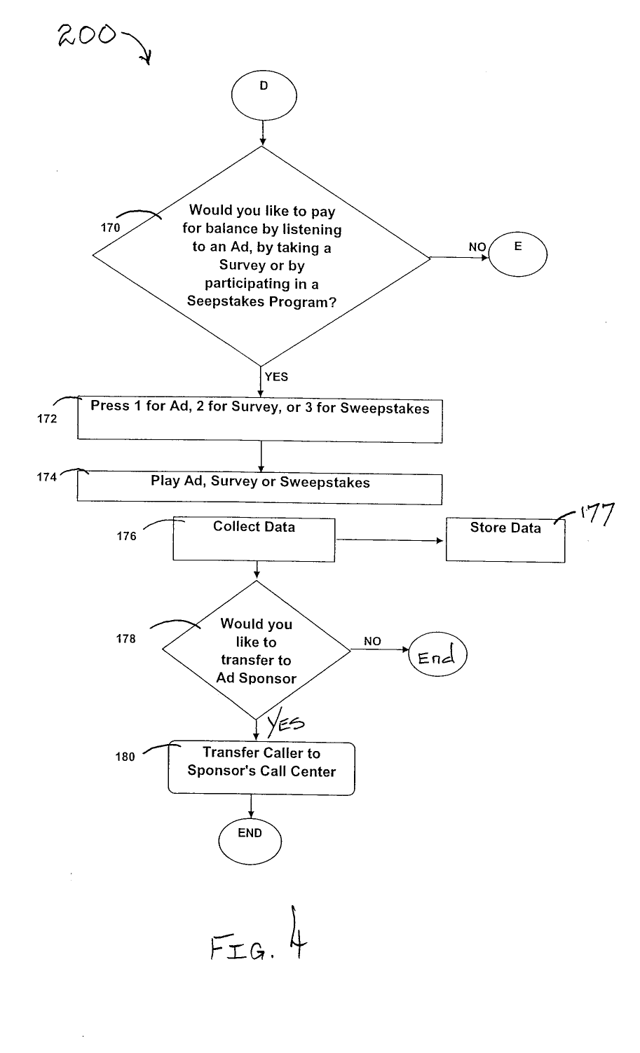

FIGS. 3 and 4 are a flowchart of a method in which a customer who has previously agreed to pay for a call can either make the payment, or in the alternative, pay for the call by participating in a marketing program. Method 200 commences with step 101.

In step 101, upon calling the BTCD platform, the customer receives a message welcoming the customer to a billing and information system, e.g., the Pay Call Now Billing and Information Center. From step 101, method 200 progresses to step 102.

In step 102, the BTCD platform prompts the customer with, “Press 1 for English, or press 2 for Spanish”. Other languages can also be offered. From step 102, method 200 progresses to step 104.

In step 104, the BTCD platform considers the customers input from step 102. If the customer pressed “2”, then method 100 advances to step 106. If the customer pressed “1”, then method 100 advances to step 108.

In step 106, the BTCD platform provides Spanish prompts.

In step 108, the BTCD platform requests that the customer provide his/her account number, e.g., the customer's cellular phone number “2125551212”. Method 200 then advances to step 110.

In step 110, the BTCD platform advises the customer of the rate for the call, e.g., $2.50 per minute. The BTCD platform also advises the customer if a payment is outstanding. From step 110, method 200 advances to step 112.

In step 112, the BTCD platform inquiries as to whether the customer would be interested in paying for the balance due by listening to sponsored ads, participating in surveys or sweepstakes, etc. From step 112, method 200 advances to step 113.

In step 113, if the customer indicates a willingness to listen to sponsored ads, participating in surveys or sweepstakes, etc., then method 200 advances to step 170 (FIG. 4). If the customer is not interested, then method 200 advances to step 114.

In step 114, the BTCD platform invites the customer to press “1” to listen to information on where and how to send a payment. From step 114, method 200 progresses to step 115.

In step 115, the BTCD platform considers the customer's input from step 114. If the customer pressed “1”, i.e., to listen to information on where and how to send a payment, then method 200 advances to step 116. Otherwise, method 200 advances to step 122.

In step 116, the BTCD platform provides instructions regarding paying by check or money order, e.g., “Please listen carefully to the following information. Make your check or money order payable to Pay Call Now. Send your payment to Pay Call Now, Trent Building, Suite 107, Irvington, New York 10533 with your cellular phone number (speak number) clearly marked on the check or money order memo section”. From step 116, method 200 progresses to step 118.

In step 118, the customer is advised as to how her/she can view his or her account. From step 118, method 200 progresses to step 120.

In step 120, the BTCD platform thanks the customer, and then method 200 branches back to step 114.

In step 122, since the customer does not want to send payment now, the BTCD platform provides a message that states, “To hear your recorded payment authorization for your Pay Call Now accepted call from “(play recorded calling party name) “press 2”. From step 122, method 200 advances to step 124.

In step 124, the BTCD platform considers the customer's response in step 122. If the customer pressed “2”, then method 200 advances to step 126. Otherwise, method 200 advances to step 134.

In step 126, the BTCD platform plays the recorded authorization (e.g., see FIG. 1B, step 70). Method 200 then advances to step 128.

In step 128, the BTCD platform invites the customer to leave a comment by pressing “3”. The method then advances to step 130.

In step 130, the BTCD platform considers the customer's input from step 128. If the customer pressed “3”, then method 200 progresses to step 132. Otherwise, method 200 advances to step 134.

In step 132, the BTCD platform records a comment from the customer. Thereafter, method 200 advances to step 134.

In step 134, the BTCD platform invites the customer to make payment now by credit or debit card, by pressing “1”. Method 200 then progresses to step 136.

In step 136, the BTCD platform considers the customer's input from step 134. If the customer pressed “1”, thus indicating the customer's intent to make payment now by credit or debit card, then method 200 advances to step 138. Otherwise, method 200 branches to step 116.

In step 138, the BTCD platform asks the customer to, “Please enter your card number after the tone, and press pound sign when finished”. From step 138, method 200 advances to step 140.

In step 140, the BTCD platform plays back the card number, and asks the customer to press “1” to confirm that the number of the card is correct, or press “2” if the number is not correct. Method 200 then progresses to step 142.

In step 142, the BTCD platform considers the customer's input from step 140. If the customer pressed “1”, thus indicating that the card number is correct, then method 200 progresses to step 144. Otherwise, method 200 loops back to step 138.

In step 144, the BTCD platform prompts the customer for the expiration date of the card. Method 200 then advances to step 146.

In step 146, the BTCD platform prompts the customer for the last three digits of the authorization code located on the card. Method 200 then progresses to step 148.

In step 148, the BTCD platform processes the payment. From step 148, method 200 progresses to step 150.

In step 150, the BTCD platform determines whether the payment is authorized by the credit or debit card company. If the payment is authorized, then method 200 progresses to step 152. If the payment is not authorized, then method 200 advances to step 154.

In step 152, since the payment is authorized by the credit or debit card company, the BTCD platform acknowledges and ends the call.

In step 154, since the payment is not authorized by the credit or debit card company, the BTCD platform informs the customer that their payment has been declined. Method 200 then progresses to step 156.

In step 156, the BTCD platform inquires whether the customer wishes to pay their balance by listening to sponsored ads, etc. Method 200 then progresses to step 158.

In step 158, the BTCD platform considers the customer's input from step 156. If the customer does not wish to listen to the sponsored ads, then method 200 returns to step 114. If, however, the customer wishes to listen to sponsored ads, then method 200 advances to step 170 (FIG. 4).

In step 170 (FIG. 4), the BTCD platform queries the customer as to whether the customer would like to pay his or her balance by listening to sponsored ads, etc. If “no”, then method 200 branches to step 114 (FIG. 3). If “yes”, then method 200 advances to step 172.

In step 172, the BTCD platform requests that the customer selects a format in which he or she wishes to listen. Thereafter, method 200 progresses to step 174.

In step 174, the BTCD platform presents material to the customer, in accordance with the selection that the customer made in step 172. From step 174, method 200 advances to step 176.

In step 176, the BTCD platform collects data, e.g., the customer's responses, based on the customer's interaction with the material presented in step 174. The BTCD platform stores the data to a storage device 177, and then method 200 progresses to step 178.

In step 178, the BTCD platform asks whether the customer is interested in being transferred directly to an ad sponsor. If “yes”, then method 100 advances to step 180. If “no”, then method 200 ends.

In step 180, the customer is transferred to the ad sponsor.

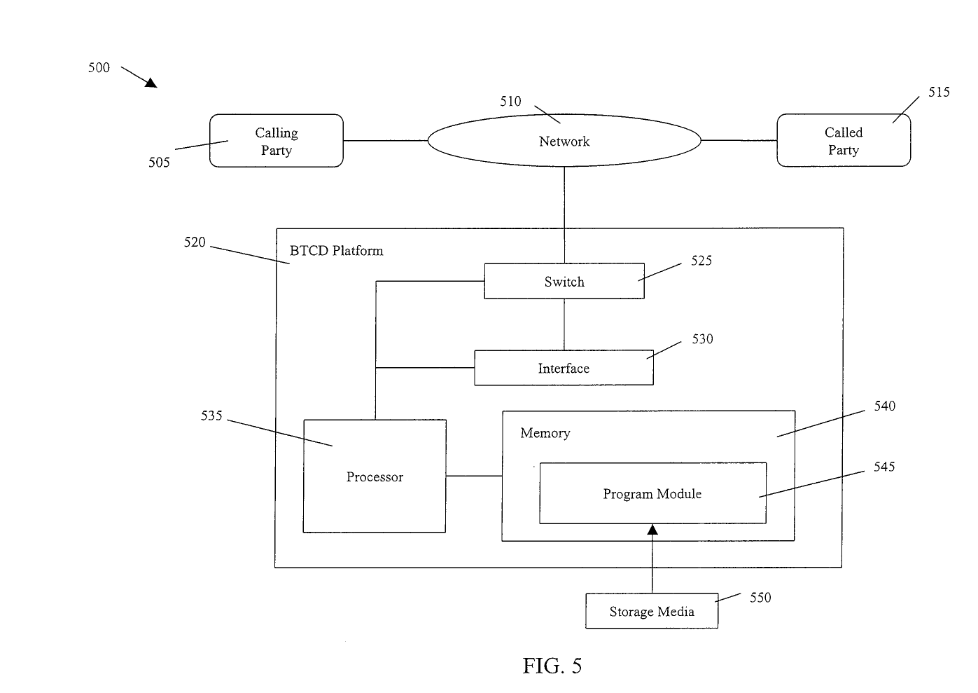

FIG. 5 is a block diagram of a system 500 for the performance of methods 100 and 200. System 500 includes a communication network 510, and coupled thereto, a calling party 505, a BTCD platform 520, and a called party 515.

BTCD platform 520 includes a switch 525, an interface 530, and a processor 535. BTCD platform 520 also includes a memory 540 that contains a program module 545 of instructions for controlling processor 535 to perform methods 100 and 200. In brief, BTCD platform 520 (a) receives from calling party 505, a request to facilitate a call, (b) obtains from called party 515, at a cellular telephone of called party 515, called party 515's consent to pay for the call, (c) provides a connection for the call, via switch 525, from calling party 505 to called party 515, and (d) sends to the cellular telephone of called party 515, a text message that contains an invoice for the call. Interface 530 is an IVR system through which BTCD platform 520 communicates with calling party 505 and called party 515.

Although BTCD platform 520 is described herein as having program module 545 installed into memory 540, program module 545 can be tangibly embodied on an external computer-readable storage media 550 for subsequent loading into memory 540. Storage media 550 can be any conventional storage media, including, but not limited to, a floppy disk, a compact disk, a magnetic tape, a read only memory, or an optical storage media. Program module 545 could also be embodied in a random access memory, or other type of electronic storage, located on a remote storage system and coupled to memory 540.

Moreover, although program module 545 is described herein as being installed in memory 540, and therefore being implemented in software, it could be implemented in any of hardware, firmware, software, or a combination thereof. Also, the term “module” is used herein to denote a functional operation that may be embodied either as a stand-alone component or as an integrated configuration of a plurality of sub-ordinate components.

Steps associated with method 100 and 200 can be performed in any order, unless otherwise specified or dictated by the steps themselves.

The techniques described herein are exemplary, and should not be construed as implying any particular limitation on the present invention. It should be understood that various alternatives, combinations and modifications could be devised by those skilled in the art. The present invention is intended to embrace all such alternatives, modifications and variances that fall within the scope of the appended claims.

What is claimed is:

1. A method, comprising:
obtaining, from a party at a cellular telephone, consent to pay for a call;
sending to said cellular telephone, a text message that contains an invoice for said call.

2. The method of claim 1,
wherein said party is a called party, and
wherein said method further comprises, prior to said obtaining, receiving from a calling party, a request to facilitate said call.

3. The method of claim 2, further comprising, providing a connection for said call from said calling party to said called party.

4. The method of claim 2, further comprising:
enabling said called party to pay for said call by receiving information; and
sending said information to said called party.

5. The method of claim 4, wherein said information is selected from the group consisting of an advertisement, a survey, and a sweepstake.

6. The method of claim 4, wherein said information is sent to said called party via said cellular telephone.

7. The method of claim 1, wherein said obtaining is performed by an interactive voice response system.

8. A system comprising:
a module that obtains, from a party at a cellular telephone, consent to pay for a call;
a module that sends to said cellular telephone, a text message that contains an invoice for said call.

9. The system of claim 8,
wherein said party is a called party, and
wherein said system receives from a calling party, a request to facilitate said call.

10. The system of claim 9, further comprising a module that provides a connection for said call from said calling party to said called party.

11. The system of claim 9, further comprising:
a module that enables said called party to pay for said call by receiving information; and
a module that sends said information to said called party.

12. The system of claim 11, wherein said information is selected from the group consisting of an advertisement, a survey, and a sweepstake.

13. The system of claim 11, wherein said information is sent to said called party via said cellular telephone.

14. A storage media comprising a program encoded thereon that is executable in a processor to perform a method that includes:
obtaining, from a party at a cellular telephone, consent to pay for a call;
sending to said cellular telephone, a text message that contains an invoice for said call.

15. The storage media of claim 14,
wherein said party is a called party, and
wherein said method also includes, prior to said obtaining, receiving from a calling party, a request to facilitate said call.

16. The storage media of claim 15, wherein said method also includes providing a connection for said call from said calling party to said called party.

17. The storage media of claim 15, wherein said method also includes:
enabling said called party to pay for said call by receiving information; and
sending said information to said called party.

18. The storage media of claim 17, wherein said information is selected from the group consisting of an advertisement, a survey, and a sweepstake.

19. The storage media of claim 17, wherein said information is sent to said called party via said cellular telephone.
